(19) United States
(12) Patent Application Publication
(10) Pub. No.: US 2026/0326683 A1
(43) Pub. Date: Oct. 22, 2026

(54) METHOD AND DEVICE FOR CALIBRATING MULTI-CAMERA

(71) Applicants: HYUNDAI MOTOR COMPANY, Seoul (KR); KIA CORPORATION, Seoul (KR)

(72) Inventor: Jung Hyun LEE, Hwaseong-si (KR)

(21) Appl. No.: 19/649,320

(22) Filed: Apr. 16, 2026

(30) Foreign Application Priority Data
Apr. 16, 2025 (KR) 10-2025-0049261

(51) Int. Cl. B60R 11/04; G06T 7/223; G06T 7/80; H04N 13/246

(52) U.S. Cl. CPC B60R 11/04; G06T 7/223; G06T 7/85; H04N 13/246; G06T 2207/10021; G06T 2207/30244

(57) ABSTRACT

Disclosed herein a method and device for calibrating multi-camera. The method includes: generating node data including a pose of a camera based on images of nodes assigned for each camera mounted on a vehicle; generating edge data including a relative pose between the nodes; generating spatiotemporal pose graph data having a loop set including at least one loop connecting the nodes with edges in a time series based on the node data and the edge data; generating optimal pose information for each node that minimizes a loop error in a loop selected by a predetermined criterion for each loop set of the pose graph data; and controlling the vehicle based on the optimal pose information. The loop error is set based on a difference of the edge data of the edges connected to the at least one node in the loop.

### CROSS-REFERENCE TO RELATED APPLICATION

This application claims the benefit of priority to Korean Patent Application No. 10-2025-0049261, filed in the Korean Intellectual Property Office on Apr. 16, 2025, the disclosure of which is incorporated herein by reference in its entirety.

### TECHNICAL FIELD

The present disclosure relates to a method and device for calibrating a multi-camera, and more specifically, to a method and device for calibrating a multi-camera, which allow calibration of a multi-camera to be flexibly performed simultaneously without restrictions on mounting poses and fields of view of a plurality of cameras.

### BACKGROUND

The matters described in this Background section are only for enhancement of understanding of the background of the disclosure, and should not be taken as acknowledgment that they correspond to prior art already known to those skilled in the art.

An autonomous driving function may be applied so that the driving of vehicles may be controlled by themself while minimizing or completely excluding driver intervention.

To implement autonomous driving, vehicles collect surrounding environment information through various sensors. Based on data acquired from these sensors, the vehicles may recognize surrounding environments and identify situations around the vehicles using the recognized information. A control plan for autonomous driving may be established according to the identified situation to control a driving device of the vehicle so that the autonomous driving may be executed.

The autonomous driving uses a plurality of camera sensors so that the vehicle may accurately recognize the surrounding environment. Calibration of a camera may be processed to correct lens distortion and achieve accurate pose estimation. In addition, calibration may be used for mapping of spaces with different dimensions by estimating poses.

Due to different poses between the plurality of camera sensors, calibration of a multi-camera may be accompanied. The calibration of multi-camera may seamlessly expand a recognition range by integrating images collected by a plurality of cameras. The calibration of multi-camera may fuse surrounding images of a vehicle in a view domain with a predetermined viewpoint, for example, a bird's-eye view (BEV) domain, using pose information of a camera. Here, since pose errors of the camera affect calibration, the calibration may be processed to utilize accurate pose information of the camera. In addition, during traveling of a vehicle, calibration for estimating a pose of a camera is performed without a target, thereby causing significant pose errors. In addition, when calibration is performed during traveling of a vehicle, the calibration may be designed to be processed without restrictions on a mounting pose and field of view of a multi-camera. Accordingly, the calibration of the multi-camera that may be processed accurately without restrictions may be one of factors considered in autonomous driving.

### SUMMARY

Various examples of the present disclosure are directed to providing a method and device for calibrating a multi-camera, which allow calibration of a multi-camera to be flexibly performed simultaneously without restrictions on mounting poses and fields of view of a plurality of cameras.

The various examples of the present disclosure are not limited to the above-described object, and other objects that are not described will be able to be clearly understood by those skilled in the art to which the present disclosure pertains based on the following description.

According to the present disclosure, a method performed by an apparatus for a vehicle may comprise assigning, to each of a plurality of sensors of the vehicle, a respective node of a plurality of nodes, generating, for each of the nodes and based on images obtained by a corresponding sensor of the plurality of sensors, node data, wherein the node data may comprise sensor pose information of the corresponding sensor, generating edge data indicating a relative pose between pairs of the nodes, generating, based on the node data and the edge data, spatiotemporal pose data having at least one loop set, wherein each of the at least one loop set may comprise at least one loop defined by node data and edge data associated with a different image acquisition time, selecting, from the at least one loop set, a loop based on a predetermined criterion, determining updated pose information for each of the nodes by reducing a loop error in the loop, wherein the loop error may be defined based on differences in edge data for edges associated with at least one node of the loop, outputting a signal indicating the updated pose information, and controlling, based on the signal, an operation of the vehicle.

According to the present disclosure, a vehicle may comprise a plurality of sensors configured to obtain images associated with a surrounding environment of the vehicle, and a processor circuit configured to cause the vehicle to assign, to each of the plurality of sensors, a respective node, generate for each of the nodes and based on images obtained by a corresponding sensor node data that may comprise sensor pose information of the corresponding sensor, generate edge data indicating a relative pose between pairs of the nodes, generate, based on the node data and the edge data, at least one loop set in which each loop set may comprise at least one loop defined by node data and edge data associated with an image acquisition time, select from each of the loop sets a loop having a minimum loop error among loops in the loop set where the minimum loop error may be defined based on differences in edge data for edges associated with at least one node of the loop, update sensor pose information for each of the nodes based on the selected loop, generate, based on the images and the updated pose information, a unified view, output a signal indicating the unified view, and control, based on the signal, autonomous driving of the vehicle.

The vehicle may further include processing configured to process variations in the images during a forward longitudinal movement of the vehicle to identify a focus of expansion and a vanishing point and to generate, based on the focus of expansion and the vanishing point, pose information for the nodes. The vehicle may further include processing configured to generate, based on the images, pitch data, yaw data, and roll data for the nodes and generate edge data based on matching features in corrected images so that images for the nodes correspond to a same perspective in a three-dimensional space. The vehicle may further include processing configured to update pose information for the nodes based on loops of the at least one loop set that share common nodes.

According to the present disclosure, an apparatus for a vehicle may comprise a plurality of sensors configured to obtain images associated with a surrounding environment of the vehicle, a processor, and a memory storing at least one instruction that, when executed by the processor, is configured to cause the apparatus to assign, to each of the plurality of sensors, a respective node, generate for each node and based on images obtained by a corresponding sensor node data that may comprise pose information of the corresponding sensor, generate edge data indicating a relative pose between pairs of the nodes, generate, based on the node data and the edge data, spatiotemporal pose graph data having at least one loop set in which each loop set may comprise at least one loop defined by node data and edge data associated with a different image acquisition time, select, from the at least one loop set, a loop based on a predetermined criterion, determine updated pose information for each of the nodes by reducing a loop error in the loop where the loop error may be defined based on differences in edge data for edges associated with at least one node of the loop, output a signal indicating the updated pose information, and control, based on the signal, an operation of the vehicle.

The apparatus may further include instructions configured to detect, based on the images obtained by the plurality of sensors, a forward longitudinal movement of the vehicle, identify, based on the forward longitudinal movement, a focus of expansion in the images, determine, based on the focus of expansion, a vanishing point in the images, and generate, based on the vanishing point, node data for each of the nodes in which the node data may comprise pitch data and yaw data for a corresponding node. The apparatus may further include instructions configured to determine the forward longitudinal movement based on changes in a relative geometric relationship between matching features across consecutive images. The apparatus may further include instructions configured to detect matching features in consecutive images, arrange the matching features in a spherical coordinate system, determine optical flow vectors between the arranged matching features, identify, based on the optical flow vectors, the focus of expansion, and determine, based on the focus of expansion, the vanishing point.

The apparatus may further include instructions configured to generate, based on consecutive images, pitch data and yaw data for each of the nodes, geometrically transform the images based on the pitch data and the yaw data to generate a transformed image for each of the nodes, detect a boundary area in the transformed image, determine a boundary area of a dynamic object, detect a lane from the transformed image, and generate, based on the boundary area and the detected lane, roll data for each of the nodes, wherein the node data for each of the nodes may comprise the pitch data, the yaw data, and the roll data. The apparatus may further include instructions configured to generate edge data based on matching between images that have been corrected so that the corrected images have a same perspective in a three-dimension. The apparatus may further include node data for each of the nodes that may comprise pose information including pitch data, yaw data, and roll data, and may include first node data for a first node and second node data for a second node, and instructions configured to generate, based on the first node data and the second node data, a relative pose of the second node with respect to the first node, wherein the relative pose may comprise relative pitch data, relative yaw data, and relative roll data.

The apparatus may further include instructions configured to generate, based on the first node data and the edge data, the second node data in which the second node data may comprise estimated pitch data, estimated yaw data, and estimated roll data respectively corresponding to the relative pitch data, the relative yaw data, and the relative roll data, and in which the spatiotemporal pose data may comprise the first node data and the second node data. The apparatus may further include predetermined criteria that may comprise selecting, from each of the at least one loop set, a loop having a minimum loop error among loops in the at least one loop set. The apparatus may further include instructions configured to identify, among the nodes, nodes that are common to loops of different ones of the at least one loop set in which each loop set corresponds to a different image acquisition time, and determine updated pose information for the identified nodes by reducing node errors of the identified nodes in which the node errors may be set based on differences in poses of the identified nodes associated with the different image acquisition time.

The features briefly summarized above for this disclosure are only examples of the detailed description of the disclosure which follow and are not intended to limit the scope of the disclosure.

### BRIEF DESCRIPTION OF THE DRAWINGS

The above and other objects, features and advantages of the present disclosure will become more apparent to those of ordinary skill in the art by describing examples thereof in detail with reference to the accompanying drawings, in which:

FIG. 1 is an exemplary view showing a vehicle that communicates with another device to transmit and receive data;

FIG. 2 shows an example of modules constituting a calibration device of a multi-camera;

FIG. 3 shows an example of an arrangement and fields of view of the multi-camera;

FIG. 4 shows an example of modules constituting a server;

FIG. 5 shows an example of a method of calibrating a multi-camera;

FIG. 6A, FIG. 6B, and FIG. 6C are exemplary views showing a camera coordinate system, a world coordinate system, and a geometric relationship between the world coordinate system and the camera coordinate system;

FIG. 7 shows an example of a process of generating node data including pitch data and yaw data;

FIG. 8A and FIG. 8B are exemplary views showing identification of a focus of expansion;

FIG. 9 shows an example of a process of generating node data including roll data;

FIG. 10A and FIG. 10B are exemplary views showing geometric transformation of a pose of an image at a node;

FIG. 11 is an exemplary view showing spatiotemporal pose graph data;

FIG. 12 is an exemplary view showing the generation of optimal pose information based on a loop error and a node error; and

FIG. 13 shows an example computing system.

### DETAILED DESCRIPTION

Hereinafter, examples of the present disclosure will be described in detail with reference to the accompanying drawings so that those skilled in the art may easily implement the present disclosure. However, the present disclosure may be implemented in various ways and is not limited to the examples described therein.

In describing examples of the present disclosure, well-known functions or constructions will not be described in detail since they may unnecessarily obscure the understanding of the present disclosure. The same constituent elements in the drawings are denoted by the same reference numerals, and a repeated description of the same elements will be omitted.

In the present disclosure, when an element is simply referred to as being “connected to”, “coupled to” or “linked to” another element, this may mean that an element is “directly connected to”, “directly coupled to” or “directly linked to” another element or is connected to, coupled to or linked to another element with the other element intervening therebetween. In addition, when an element “includes” or “has” another element, this means that one element may further include another element without excluding another component unless specifically stated otherwise.

In the present disclosure, the terms first, second, etc. are only used to distinguish one element from another and do not limit the order or the degree of importance between the elements unless specifically mentioned. Accordingly, a first element in an example could be termed a second element in another example, and, similarly, a second element in an example could be termed a first element in another example, without departing from the scope of the present disclosure.

In the present disclosure, elements that are distinguished from each other are for clearly describing each feature, and do not necessarily mean that the elements are separated. That is, a plurality of elements may be integrated in one hardware or software unit, or one element may be distributed and formed in a plurality of hardware or software units. Therefore, even if not mentioned otherwise, such integrated or distributed examples are included in the scope of the present disclosure.

In the present disclosure, elements described in various examples do not necessarily mean essential elements, and some of them may be optional elements. Therefore, an example composed of a subset of elements described in an example is also included in the scope of the present disclosure. In addition, examples including other elements in addition to the elements described in the various examples are also included in the scope of the present disclosure.

The advantages and features of the present disclosure and the way of attaining them will become apparent with reference to examples described below in detail in conjunction with the accompanying drawings. Examples, however, may be embodied in many different forms and should not be constructed as being limited to example examples set forth herein. Rather, these examples are provided so that this disclosure will be complete and will fully convey the scope of the disclosure to those skilled in the art.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all combinations of the listed items. For example, “at least one of A or B” may refer to (1) at least one A; (2) at least one B; or (3) at least one A and at least one B.

In the present disclosure, expressions of location relations used in the present specification such as “upper”, “lower”, “left” and “right” are employed for the convenience of explanation, and in case drawings illustrated in the present specification are inversed, the location relations described in the specification may be inversely understood.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium to be executed on a computer. The medium may either continuously store a computer-executable program or temporarily store the program for execution or download. Furthermore, the medium may be a variety of recording or storage means in the form of a single hardware device or multiple combined hardware devices and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

One or more features associated with autonomous driving control may be activated based on configured autonomous-driving settings (e.g., based on at least one of an autonomous-driving classification or a selected autonomous-driving level of a vehicle). Based on the feature of self-correcting multi-sensor pose calibration (e.g., automatically refining camera poses, correcting sensor misalignment, or improving fused perception accuracy, etc.), the vehicle may adjust autonomous-driving control behaviors. For example, lane-keeping control may be updated using calibrated camera poses, collision-avoidance timing may be adjusted based on improved object detection, or braking/acceleration control may be modified to reflect corrected multi-sensor geometry. The vehicle control may include various operational controls associated with the vehicle (e.g., autonomous-driving control, sensor control, braking control, braking-time control, acceleration control, acceleration-change-rate control, alarm-timing control, forward-collision-warning-time control, etc.).One or more auxiliary devices (e.g., engine brake, exhaust brake, hydraulic retarder, electric retarder, regenerative brake, etc.) may also be controlled based on the feature of self-correcting multi-sensor pose calibration (e.g., refined camera poses, corrected sensor alignment, or improved multi-sensor perception accuracy, etc.). For example, a regenerative brake may be modulated more precisely when lane boundaries are detected more accurately, an engine brake may engage earlier when corrected sensor poses improve distance estimation, or a retarder may be adjusted based on stabilized perception of road grade or curvature. One or more communication devices (e.g., a modem, a network adapter, a radio transceiver, an antenna, etc., capable of communicating via Ethernet, Wi-Fi, NFC, Bluetooth, LTE, 5G NR, V2X, etc.) may also be controlled based on the feature of self-correcting multi-sensor pose calibration (e.g., refined camera poses, corrected sensor alignment, or improved fusion accuracy for environmental perception, etc.). For example, V2X transmissions may be scheduled when corrected poses improve detection of nearby vehicles, 5G or LTE uplink reporting may prioritize updated perception data, or antenna-beam steering may be adjusted based on stabilized vehicle orientation inferred from corrected sensor poses. Minimum risk maneuver (MRM) operation(s) may also be controlled based on the feature of self-correcting multi-sensor pose calibration (e.g., refined camera poses, corrected sensor alignment, or improved detection of road edges and obstacles, etc.). For example, an MRM deceleration profile may be adjusted when corrected poses improve lane-boundary estimation, a safe-stop trajectory may be recalculated using more accurate obstacle locations, or a pull-over maneuver may be selected when stabilized multi-sensor geometry improves free-space detection. A minimal risk maneuvering operation (e.g., a minimal risk maneuver, a minimum risk maneuver) may be a maneuvering operation of a vehicle to minimize a risk of collision with surrounding vehicles to reach a lowered (e.g., minimum) risk state. A minimal risk maneuver may be activated during autonomous driving of the vehicle when a driver is unable to respond to a request to intervene. During the minimal risk maneuver, one or more processors of the vehicle may control a driving operation of the vehicle for a set period of time. Biased driving operation(s) may also be controlled based on the feature of self-correcting multi-sensor pose calibration (e.g., refined camera poses, corrected sensor alignment, or improved multi-sensor lane-boundary detection, etc.). For example, a biased lateral offset may be adjusted when corrected poses provide more accurate lane-edge geometry, or a biased distance from adjacent vehicles may be updated when improved perception stabilizes relative-position estimates. A driving control apparatus may perform a biased driving control by maintaining a lateral distance between the position of the center of the vehicle and the center of the lane and may control the vehicle to stay in the lane but not necessarily at its center. The apparatus may determine a biased target lateral distance comprising an intentionally adjusted distance from a reference point, such as the center of a lane or another vehicle, during maneuvers such as lane changes. This adjustment may be made to improve the vehicle's stability, safety, or performance under varying driving conditions. For example, during a lane change, the system may bias the lateral distance to maintain a safer gap from adjacent vehicles, considering factors such as the vehicle's speed, road conditions, or the presence of obstacles. One or more sensors (e.g., IM sensors, cameras, LiDAR, RADAR, blind-spot monitoring sensors, lane-departure warning sensors, parking sensors, light sensors, rain sensors, traction-control sensors, ABS sensors, tire-pressure sensors, seatbelt sensors, airbag sensors, fuel sensors, emission sensors, throttle-position sensors, inverters, converters, motor controllers, power distribution units, auxiliary power modules, charging interfaces, etc.) may also be controlled based on the feature of self-correcting multi-sensor pose calibration (e.g., refined camera poses, corrected sensor alignment, or improved fusion accuracy for environmental perception, etc.). For example, a camera's exposure or field of view may be adjusted when corrected poses improve scene geometry, a RADAR may update filtering thresholds based on more accurate relative-position estimates, or an IMU may recalibrate drift-compensation parameters using stabilized multi-sensor alignment. Operation control for autonomous driving may include various driving controls (e.g., acceleration, deceleration, steering control, gear shifting, braking, traction control, stability control, cruise control, lane-keeping assist, collision-avoidance control, emergency-brake assistance, traffic-sign recognition, adaptive headlight control, etc.). An autonomous driving level and/or autonomous driving activation/deactivation may also be controlled based on the feature of self-correcting multi-sensor pose calibration (e.g., refined camera poses, corrected sensor alignment, or improved recognition of lane geometry and obstacles, etc.). For example, autonomous-driving activation may proceed only when corrected poses stabilize lane and object detection, or a lower autonomous-driving level may be selected when pose-graph errors indicate degraded perception quality. A driving control apparatus may perform an autonomous-driving level control (e.g., a change of an autonomous-driving level or required user attentiveness) or cause deactivation of autonomous driving. For example, the required user attentiveness may be increased so the driver places his or her hands on the wheel more often (e.g., at least once in a threshold period such as five seconds, 30 seconds, or one minute), or looks ahead more often within a threshold period. By changing the autonomous-driving level, one or more video contents may not be displayed on a display of the vehicle. According to the present disclosure, a vehicle equipped with many sensors (e.g., cameras) may automatically determine how each sensor is positioned while the vehicle is moving, without needing special targets or a fixed setup. As the vehicle drives, each sensor captures a series of images, and how objects in those images shift to understand the sensor's direction (e.g., whether the sensor is angled upward or downward, turned left or right, or slightly rotated) are analyzed. Features that naturally appear on the road, such as lane markings and nearby vehicles, may also be used to further refine these angle estimates. Using this information, a connected data structure, which compares sensor poses over time, is created, where inconsistencies occur is identified, and updated pose information for all sensors together is determined. With these updated poses, images from different sensors may be merged into a unified view, such as a bird's-eye view around the vehicle, enabling more accurate recognition of the surrounding environment and improved autonomous driving performance.

Hereinafter, examples of the present disclosure will be described with reference to the accompanying drawings.

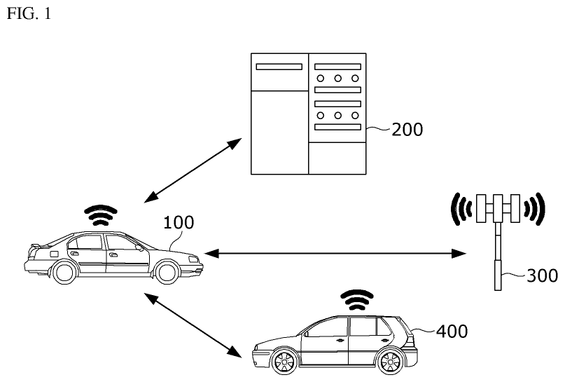

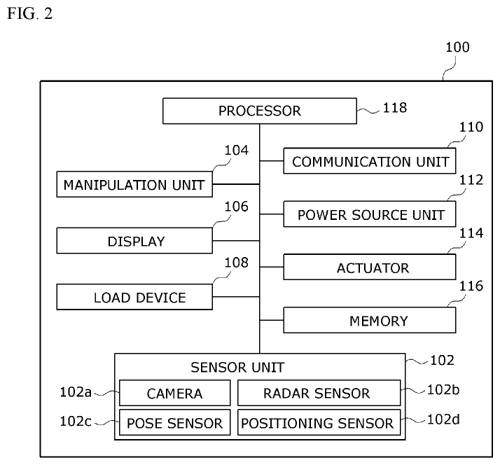

Hereinafter, a vehicle that performs calibration of a multi-camera, recognizes objects around the vehicle based on images of the calibrated multi-camera, and controls driving based on the recognized objects will be described with reference to FIGS. 1 and 2.

FIG. 1 is an exemplary view showing a vehicle that communicates with another device to transmit and receive data.

Referring to FIG. 1, a vehicle 100 may be driven based on electric energy or fossil energy. For example, in the case of electric energy, the vehicle 100 may be a pure battery-based vehicle driven by only a high-voltage battery or may adopt a gas-based fuel cell as an energy source. In addition, the fuel cell may use various types of gases that may generate electric energy, and the gas may be charged to the vehicle 100, for example, in a liquefied state. Here, the gas may be, for example, hydrogen. However, the present disclosure is not limited thereto, and various gases may be applied (e.g., ammonia, methanol-reformed hydrogen, or synthetic fuels, etc.). In the case of fossil energy, the vehicle 100 may be driven based on fuel such as gasoline, diesel, liquefied gas, etc., and provided with an internal combustion engine that drives an actuator 114 by combustion of the fuel. The engine may be included in a power source unit 112 from the perspective of providing driving rotation forces of wheels. As another example, the vehicle 100 may drive the actuator 114 selectively using an internal combustion engine based on fossil energy and the energy of an electric battery and may be a hybrid-type vehicle (e.g., parallel hybrid, series hybrid, or plug-in hybrid, etc.).

The vehicle 100 may be a movable device. The vehicle 100 is a ground vehicle that travels on the ground and may be a typical passenger or commercial vehicle, a purpose-built vehicle (PBV), etc. The vehicle 100 may be a four-wheeled vehicle, for example, a passenger car, an SUV, or a small truck, or a vehicle with more than four wheels, for example, a bus, an oversized truck, a container transport vehicle, a heavy equipment vehicle, etc. The vehicle 100 may be a robot in a broad sense, such as a means of transportation, and the robot may move using wheels, tracks, or other moving modules (e.g., articulated tracks, omni-wheels, or mecanum wheels, etc.).

The vehicle 100 may be traveled manually by a user or controlled by autonomous driving. The autonomous driving may be implemented as semi-autonomous driving or full autonomous driving. The full autonomous driving may be provided as autonomous movement in which a processor 118 of the vehicle 100 has full control authority without user intervention even when a traveling situation is uncertain. The semi-autonomous driving may be provided as autonomous movement that requires driver intervention depending on a specific traveling situation. The semi-autonomous driving may be implemented by allowing a user to perform manual driving by deactivating autonomous driving in case of a specific situation and transferring control authority to the user. According to the level of the autonomous driving defined by the Society of Automotive Engineers (SAE), the semi-autonomous driving corresponds to autonomous driving levels 1 to 4, and the full autonomous driving corresponds to level 5 (e.g., hands-off highway driving at Level 3 or fully driverless urban navigation at Level 5, etc.).

The vehicle 100 may communicate with other devices 200 and 300 or another vehicle 400. The other devices may include, for example, a server 200 for supporting various control, state management, and traveling of the vehicle 100, an intelligent transportation system (ITS) device 300 for receiving information from an ITS, various types of user devices, etc. The server 200 may be, for example, an external device operated by a vehicle manufacturer or provided to service autonomous driving and may receive connected data of the vehicle 100 or transmit data required for manual and autonomous driving. To support autonomous driving and various services of the vehicle 100, the server 200 may transmit various types of information and software modules that are used for controlling the vehicle 100 to the vehicle 100 in response to the request and data transmitted from the vehicle 100 and the user device (e.g., map updates, calibration parameters, or driving policy updates, etc.).

The ITS device 300 is, for example, a road side unit (RSU) and may exchange vehicle recognition data, traveling control and state data, surrounding environmental data of a vehicle, map data, etc., with the vehicle 100 through a vehicle-to-infrastructure (V2I) communication to assist to a user driving his or her vehicle or support the autonomous driving of the vehicle 100. The vehicle 100 may exchange the above listed data with another vehicle 400 through a vehicle-to-vehicle (V2V) to support manual driving or autonomous driving (e.g., exchanging obstacle warnings, speed intentions, or cooperative lane-change information, etc.).

The vehicle 100 may communicate with another vehicle or other devices based on cellular communication, wireless access in vehicular environment (WAVE) communication, dedicated short range communication (DSRC), short-range communication, or another communication method.

For example, the vehicle 100 may use a communication network such as Long Term Evolution (LTE) or 5G, a Wi-Fi communication network, a WAVE communication network, etc., as a cellular communication network to communicate with the server 200, the ITS device 300, and another vehicle 400 (e.g., via 5G-NR V2X, IEEE 802.11p, or Wi-Fi Direct, etc.). As another example, the DSRC or the like used in the vehicle 100 may be used for communication between vehicles. A communication method between the vehicle 100, the server 200, the ITS device 300, another vehicle 400, and the user device is not limited to the above example.

FIG. 2 shows an example of modules that constitute a vehicle.

In the present disclosure, the vehicle 100 is exemplified as performing calibration of a multi-camera 102a while traveling. From this perspective, the vehicle 100 may serve as a device for performing calibration of the multi-camera 102a in the present disclosure. As another example, a device for calibration may be a mobile device different from the vehicle 100. The mobile device may have a multi-camera to process calibration of the multi-camera 102a and transmit pose information (or optimal pose information) (e.g., extrinsic parameters, intrinsic parameters, or correction offsets, etc.) of the camera obtained by calibration to the vehicle 100. As still another example, the mobile device may have a multi-camera to transmit images acquired from the camera to the server 200, and the server 200 may perform calibration of the multi-camera and transmit the pose information of the camera to the vehicle 100. According to this example, the server 200 may be a device for calibration (e.g., cloud-based calibration, fleet-wide calibration updates, or remote sensor-health verification, etc.).

The vehicle 100 may include a sensor unit 102, a manipulation unit 104, a display 106, a load device 108, and a communication unit 110.

The sensor unit 102 may include various types of sensors for detecting various states and situations that occur in an external surrounding environment, internal system, user manipulation, and boarding space of the vehicle 100 (e.g., illumination changes, cabin occupancy, or roadway conditions, etc.).

Specifically, the sensor unit 102 may include the outward-facing camera 102a, a radar sensor 102b, etc., to recognize dynamic and static objects that are present around the vehicle 100 (e.g., other vehicles, pedestrians, bicycles, or roadside structures, etc.).

The camera 102a may recognize an image of an external object while used in the vehicle 100 to generate image data and transmit the image data to the processor 118. In the present disclosure, images may be referred to as image data, and hereinafter, the images and the image data may be described interchangeably.

The camera 102a may be mounted on a specific site of the vehicle 100, for example, a front site, rear site, and side site of the vehicle 100 (e.g., on a bumper, roofline, or side mirror, etc.). When a plurality of cameras 102a are mounted on each site, they may be referred to as a multi-camera in the present disclosure (e.g., front multi-camera, rear multi-camera, or surround-view multi-camera, etc.). In the present disclosure, for convenience of description, the reference numerals of the plurality of cameras and the multi-camera may be denoted as “102a” (e.g., using a shared label for clarity and reduced drawing complexity, etc.)

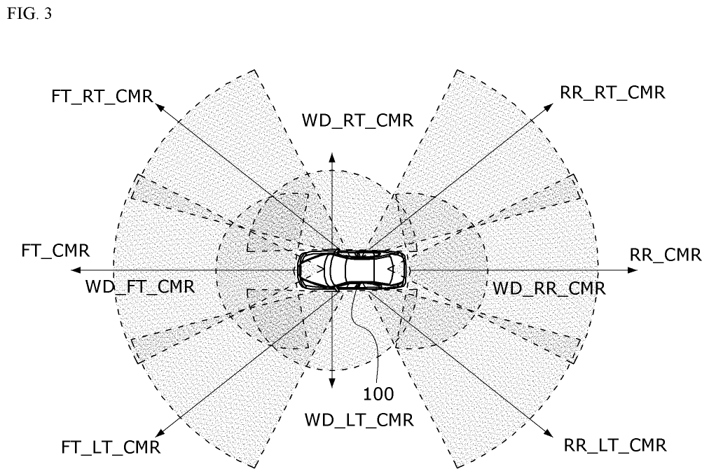

As shown in FIG. 3, the camera 102a may include wide-angle cameras mounted on each of front and front side surfaces of the vehicle 100 and having a long-distance field of view, fish-eye cameras mounted on front/rear/right/left sides of the vehicle 100 and having a short-distance field of view, and wide-angle cameras mounted on a rear and adjacent rear side surfaces of the vehicle 100 and having a long-distance field of view (e.g., for lane detection, parking assistance, or obstacle classification, etc.). FIG. 3 shows an example of an arrangement and fields of view of the multi-camera. In the present disclosure, an example in which ten cameras 102a are provided in the vehicle 100 is described, but the number of cameras and the fields of view are not limited thereto. In FIG. 3, a front wide-angle camera, a front right wide-angle camera, and a front left wide-angle camera are denoted as FT_CMR, FT_RT_CMR, and FT_LT_CMR, respectively. A rear wide-angle camera, a rear right wide-angle camera, and a rear left wide-angle camera are denoted as RR_CMR, RR_RT_CMR, and RR_LT_CMR, respectively. The fish-eye cameras mounted on the front/rear/right/left sides are denoted as WD_FT_CMR, WD_RR_CMR, WD_RT_CMR, and WD_LT_CMR, respectively.

Image data acquired from the plurality of cameras 102a may be referred to as multi-view image data. Although not shown, the sensor unit 102 may further include a camera facing the interior of the vehicle 100 (e.g., a driver monitoring camera or a cabin surveillance camera, etc.).

The radar sensor 102b may emit radio waves of a specific frequency to a peripheral area of the vehicle 100 to generate radar data through radio waves reflected from an external object in order to identify the presence, a relative distance, speed, direction, etc., of the external object. In the present disclosure, the radar sensor 102b may be a type of heterogeneous sensor that recognizes objects in a different manner from the camera 102a and differs from the camera 102a (e.g., operating reliably in rain, fog, or low-light conditions, etc.).

In the present disclosure, an example in which no lidar sensor (not shown) is mounted is described, but in other examples, the lidar sensor may be mounted on the vehicle 100. The lidar sensor may generate point cloud data as data recognized by the external object and transmit the point cloud data to a processor in order to generate three-dimensional spatial information that identifies at least the shape of the external object (e.g., vehicle contours, roadside curbs, or vegetation boundaries, etc.). The lidar sensor may be a different type of sensor that differs from the camera 102a.

The sensor unit 102 may include a pose sensor 102c. The pose sensor 102c may detect, for example, states of three axes of the vehicle 100, for example, yaw, pitch, and roll, and output various pose states of the vehicle based on the above factors. Examples of the pose sensor may include an inertial measurement unit (IMU) sensor, a gyro sensor, etc. The processor 118 may generate pose data based on the pose state (e.g., sudden braking, sharp turning, or vehicle tilting, etc.).

In addition, the sensor unit 102 may include a positioning sensor 102d for identifying a position of the vehicle 100. The positioning sensor 102d may be, for example, a global positioning system (GPS) sensor or a global navigation satellite system (GNSS) sensor, but is not limited thereto (e.g., RTK-GNSS, differential GPS, or satellite-based augmentation, etc.).

In addition, although not shown in FIG. 2, the sensor unit 102 may include a brake sensor and a wheel sensor. The brake sensor may detect a braking degree of a brake, and the wheel sensor may detect, for example, a wheel speed, wheel rotation angle, and wheel rotation angular speed of a wheel (e.g., for ABS control, traction control, or stability analysis, etc.). In the present disclosure, the sensors of the sensor unit 102 referred to the description of the example are mainly described, but sensors for detecting various situations, which are not listed above, may be additionally included (e.g., rain sensors, ultrasonic sensors, or cabin climate sensors, etc.).

The manipulation unit 104 may be configured as a module manipulated by a user for driving. For example, the manipulation unit 104 may be a steering wheel for manual driving, an automatic or manual transmission, an accelerator pedal, a brake pedal, a gear transmission, etc. The manipulation unit 104 may further include an interface for using, deactivating, and selecting a specific function of an autonomous driving mode requested by the user so that the user may use the autonomous driving function. To receive various requests related to autonomous driving, the manipulation unit 104 may be composed of, for example, a hard type interface provided at a predetermined location in the vehicle 100 or a soft type interface that may be touched on the display 106 (e.g., buttons, touchscreens, or voice-activated controls, etc.).

The display 106 may serve as a user interface. The display 106 may be controlled by the processor 118 to display an operation state, control state, route/traffic information, and remaining-energy information of the vehicle 100, a content requested by a driver, etc. In addition, the display 106 may be configured as a touch screen capable of detecting a driver input and may receive the driver's request that instructs the processor 118 (e.g., selecting navigation, adjusting climate controls, or activating driver-assistance features, etc.).

The communication unit 110 may support mutual communication with the server 200, the ITS device 300, the nearby vehicle 400, etc. The communication unit 110 may include, for example, a module for processing cellular communication, WAVE, DSRC communication, etc. In the present disclosure, a transceiver may transmit data generated or stored during driving to the server 200 and receive data and a software module transmitted from the server 200 as a specific type of signal (e.g., firmware updates, HD-map data, or calibration parameters, etc.).

The communication unit 110 may support communication for transmitting or receiving signals related to data, control, commands, and requests between the components of FIG. 2. The components may be devices or modules denoted as reference numerals 102 to 118 shown in FIG. 2. The communication unit 110 may transmit signals transmitted between the components, that is, signals related to data, control, commands, and requests, to a communication bus using, for example, controller area network (CAN) communication, and transmit the signals to a specific component (e.g., actuator 114, display 106, or sensor unit 102, etc.). The data, control, commands, and requests transmitted via the may communication may be referred to as may data.

The communication unit 110 may support communication with electronic devices of passengers in the vehicle 100 (e.g., smartphones, tablets, or wearable devices, etc.). In the present disclosure, the vehicle 100 may transmit and receive data used in the method according to the present disclosure with an external device through the communication unit 110.

In addition, the vehicle 100 may include a power source unit 112 and the actuator 114.

The power source unit 112 may generate and supply power and electric power that are used in a driving power system and a non-driving power system, such as the actuator 114. The non-driving power system may include, for example, the sensor unit 102, the manipulation unit 104, the display 106, the load device 108, the communication unit 110, etc., but is not limited thereto, and may include various components for implementing sensing, interface, communication, and convenience functions other than components directly involved in a driving operation (e.g., cabin HVAC units, infotainment modules, or lighting controllers, etc.).

When the vehicle 100 is driven based on electric energy, the power source unit 112 may be configured as, for example, an electric battery charged from the outside or configured as a combination of an electric battery and a fuel cell that charges the battery. In the case of a combination of the electric battery and the fuel cell, the power source unit 112 may include a tank that stores a material used to produce power for the fuel cell, for example, liquefied hydrogen (e.g., LH2, compressed hydrogen, or ammonia-derived hydrogen, etc.). When the vehicle 100 is driven based on fossil energy, the power source unit 112 may be configured as an internal combustion engine. In addition, when the vehicle 100 is a hybrid type, the power source unit 112 may be provided as a combination of the internal combustion engine and the electric battery.

The actuator 114 may have at least one module that implements a driving operation and perform the driving operation based on signals according to the user request from the manipulation unit 104 or the demand of the processor 118. The signal according to the demand may be related to at least one of longitudinal control such as acceleration/deceleration, transverse control such as steering, and gear shifting. Here, the gear shifting may be processed by a request of a manual driving user using a gear transmission or a request of the processor 118 in autonomous driving (e.g., automated downshifting, automated parking maneuvers, or cruise-control adjustments, etc.).

The actuator 114 may have a wheel driving unit and a mechanical component and an electronic module for implementing a driving operation in the wheel driving unit to perform a driving operation according to commands of the processor 118 by a manual manipulation of the user or autonomous driving. When the vehicle 100 is operated based on electric energy, the vehicle 100 may include an assembly for transmitting the requested driving operation to a wheel driver (e.g., inverter modules, motor controllers, or torque-vectoring units, etc.). When the vehicle 100 is operated based on fossil energy, the actuator 114 may include a transmission and a gear module for transmitting the power of an internal combustion engine.

The wheel driver may include a plurality of wheels, a driving force generation module for generating a driving force to impart the driving force to wheels or transmitting the driving force, a brake module for decelerating the driving of the wheels, a steering module for achieving transverse control of the wheels, etc. When the vehicle 100 is driven based on electric energy, the driving force generation module may be provided as a motor assembly for generating a driving force based on power output from the electric battery. When the vehicle 100 is driven based on fossil energy, the driving force generation module may be an engine or a transmission assembly. The brake module of the electricity-based vehicle 100 may further have a regenerative brake function (e.g., energy-recapture during deceleration, downhill control, or one-pedal driving, etc.).

In addition, the vehicle 100 may include a memory 116 and the processor 118.

The memory 116 may store applications and various types of data for controlling the vehicle 100 and load the applications or read or write the data at the request of the processor 118. In the present disclosure, the memory 116 may include an application that processes calibration of the plurality of cameras 102a, for example, according to the present disclosure. The calibration may include a process of generating optimal pose information of each camera 102a. The optimal pose information is rotation data of the camera 102a and may include pitch data, yaw data, and roll data. The optimal pose information may include external geometric parameters for converting an image of each camera 102a into a view at a predetermined perspective. The view at the predetermined perspective is, for example, a BEV, but is not limited thereto (e.g., top-down view, panoramic view, or stitched surround-view, etc.). In addition, the memory 116 may retain internal geometric parameters of each camera 102a. Examples of the internal geometric parameters may include matrix data and the like according to focus, principal points, and the above elements (e.g., distortion coefficients, focal-length values, or intrinsic calibration matrices, etc.).

The processor 118 may perform the overall control of the vehicle 100. The processor 118 may be configured to execute applications and instructions that are stored in the memory 116. The processor 118 may generate signals related to control of components of the vehicle 100 according to driving control requests in manual driving and autonomous driving. The component may be at least one of various members described in FIG. 2 (e.g., actuator 114, display 106, or sensor unit 102, etc.). The processor 118 may include, for example, at least one of a central processing unit (CPU), a graphical processing unit (GPU), and a neural processing unit (NPU) (e.g., for parallel image processing, neural-network inference, or sensor fusion, etc.). The processor 118 may serve as a controller in another example. A controller may include the processor, a cache memory, a bus interface, etc., and may be, for example, an electric control unit (ECU) (e.g., a camera ECU, chassis ECU, or ADAS ECU, etc.).

The processor 118 may perform a process of generating node data including the pose of the camera 102a based on images of nodes set for each camera 102a. The processor 118 may perform a process of generating edge data including relative poses between nodes. In addition, the processor 118 may perform a process of generating spatiotemporal pose graph data that provides a set of loops including at least one loop connecting nodes to edges in a time series based on the node data and the edge data (e.g., representing successive movements, repeated viewpoints, or overlapping sensor coverage, etc.). The processor 118 may perform a process of generating optimal pose information for each node that minimizes loop errors in loops selected by a predetermined criterion for each loop set of the pose graph data. The processor 118 may convert the images of the multi-camera 102a into views at a predetermined perspective based on the optimal pose information and control predetermined operations of the vehicle 100, for example, traveling of the vehicle 100, based on the views (e.g., lane-keeping control, collision-avoidance braking, or parking assistance, etc.).

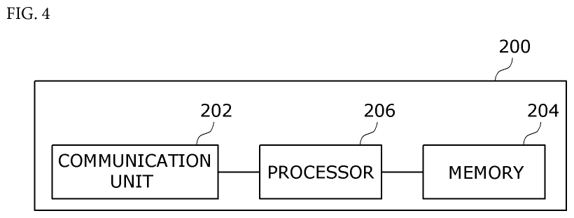

FIG. 4 shows an example of modules constituting a server.

The server 200 may transmit response data according to the request of the vehicle 100 to the vehicle 100 and also transmit information for supporting an application built into the vehicle 100 and traveling of the vehicle to the vehicle 100 (e.g., calibration parameters, map tiles, or driving-policy updates, etc.). The server 200 may include a communication unit 202, a memory 204, and a processor 206.

The communication unit 202 may transmit and receive data with an external device, support mutual communication with the vehicle 100 in the present disclosure, and exchange data with the vehicle 100.

The memory 204 may store the application and various data for operating the server 200 and load the application or read and record the data at the request of the processor 206. In the present disclosure, the memory 204 may manage related data and software for calibration processing of the multi-camera 102a (e.g., pose-estimation models, camera-intrinsic tables, or geometric-correction modules, etc.).

The processor 206 may perform the overall control of the server 200. The server 200 may be configured to execute the application and instructions that are stored in the memory 204. The processor 206 may execute the application to process and respond to a user request transmitted from the vehicle 100. The server 200 may transmit data and software related to calibration processing to the vehicle 100 through the communication unit 202.

In the present disclosure, the processor 206 is, for example, configured as a single processing module. As another example, the processor 206 may be composed of a plurality of processing modules so that the above processing may be performed by the processing modules (e.g., distributed cloud processors, edge-computing units, or redundant fail-safe processors, etc.).

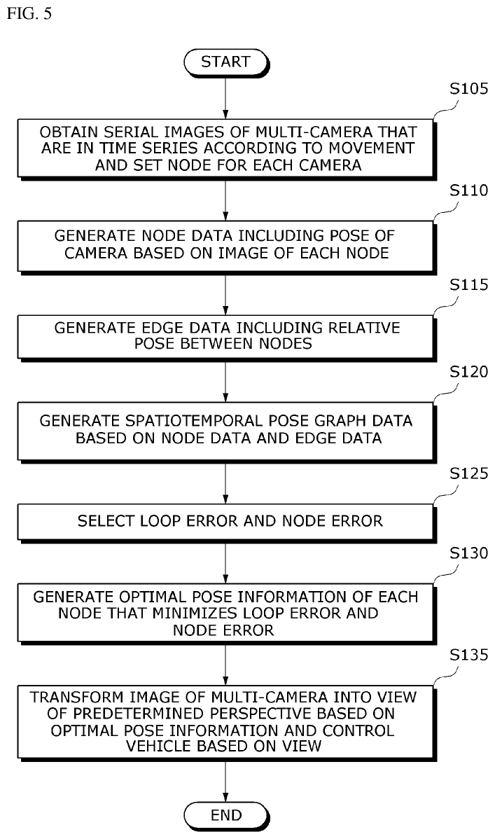

Hereinafter, a method of calibrating a multi-camera will be described with reference to FIGS. 5 to 12. FIG. 5 is shows an example of a method of calibrating a multi-camera. Hereinafter, the method may be described as performed by the vehicle 100 that has the multi-camera and processes calibration of the multi-camera. From this perspective, the vehicle 100 may serve as a device for performing calibration of the multi-camera 102a (e.g., during normal driving, low-speed maneuvering, or parking operations, etc.). However, when the mobile device or the server 200 serves as a calibration device, the following description may be applied to the mobile device or the server 200 unless technically contradictory. The method is mainly performed by the processor 118 of the vehicle 100, but the processor 118 may be abbreviated as the vehicle 100 for convenience of description, or these terms may be used interchangeably (e.g., referring collectively to on-board processing steps, decision-making logic, or calibration computations, etc.).

Referring to operation S105 of FIG. 5, the processor 118 of the vehicle 100 may acquire images of the multi-camera 102a, which are serial images in a time series according to movement, and may assign a node to each camera 102a (e.g., one node per timestamp, per sensor, or per viewpoint, etc.).

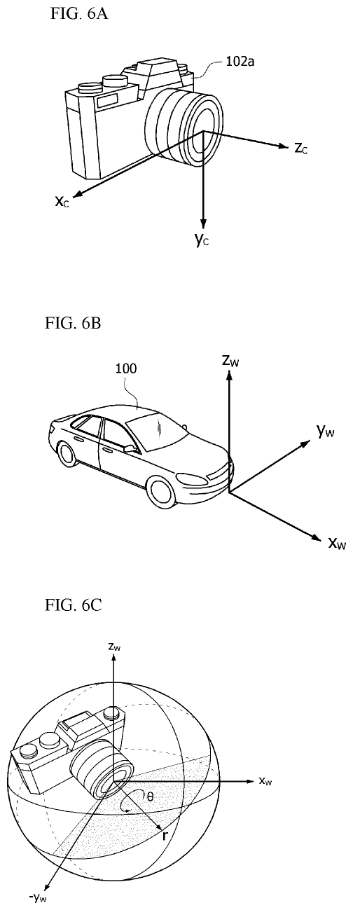

The images acquired from the camera 102a may be provided in the camera coordinate system as shown in FIG. 6A. FIGS. 6A to 6C are exemplary views showing a camera coordinate system, a world coordinate system, and a geometric relationship between the world coordinate system and the camera coordinate system. The camera coordinate system may be established for each camera. Optimal pose information for integrating images of each camera coordinate system into a common coordinate system, for example, the world coordinate system, may be generated during calibration. The world coordinate system may be a coordinate system centered on a predetermined point different from that of the camera 102a. The world coordinate system may be a vehicle-centered coordinate system centered on a front point of the vehicle 100 as shown in FIG. 16B. The world coordinate system may be a coordinate system employed in a view at a predetermined perspective in which the images of the multi-camera 102a are integrated. The view at the predetermined perspective may be, for example, a BEV (e.g., stitched surround-view, road-edge view, or curb-alignment view, etc.). FIG. 6C shows a geometric relationship between the camera coordinate system and the world coordinate system. The pose of the camera 102a may be defined as a geometric relationship between the camera coordinate system and the world coordinate system as shown in FIG. 6C. For parameterization, a rotation vector may be defined as an optical axis z_{c} of a camera in the world coordinate system, and a rotation angle may be defined as the rotation of the optical axis z_{c} in the world coordinate system (e.g., tilting upward, rotating laterally, or adjusting for sensor mounting offsets, etc.). As shown in FIG. 6C, the pose of the camera in the world coordinate system may be parameterized as the rotation vector r and the rotation angle θ. In the present disclosure, the calibration may perform a process of estimating the rotation vector r and the rotation angle θ in the world coordinate system as shown in FIG. 6C. In the present disclosure, the rotation vector and the rotation angle may be referred to as rotation data, pose data, or pose of the camera 102a (e.g., describing camera orientation, viewing direction, or alignment parameters, etc.).

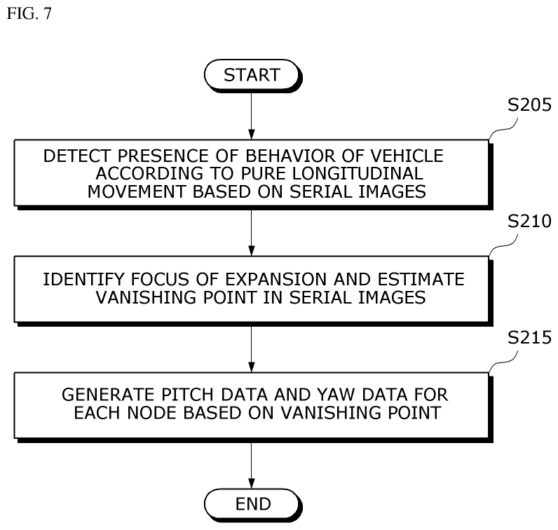

Referring to operation S110 of FIG. 5, node data including the pose of the camera may be generated based on the image of each node. The generation of the node data will be described in detail with reference to FIGS. 7 to 10.

FIG. 7 is shows an example of a process of generating node data including pitch data and yaw data. In FIG. 7, a process of generating pitch data and yaw data for each node may be temporal calibration.

Referring to operation S205 of FIG. 7, the processor 118 may detect whether there is a behavior of a vehicle according to pure longitudinal movement based on at least one of the time-series serial images of the multi-camera 102a (e.g., forward acceleration, coasting, or steady-speed motion, etc.).

The pure longitudinal movement may be determined based on a relative geometric relationship between matching features in the serial images. Describing the detection of the pure longitudinal movement in detail, a direction of the pure longitudinal movement may be parallel to an x_{w} axis of the world coordinate system shown in FIG. 6 (e.g., straight-ahead driving on a highway, tunnel, or long corridor, etc.).

The pure longitudinal movement may be detected by estimating a relative pose of the camera 102a. To estimate the relative pose, the processor 118 may match features in serial images of a particular camera, for example, a front wide-angle camera (e.g., FT_CMR, FT_RT_CMR, or FT_LT_CMR, etc.). The serial images may include temporally preceding and following images. The matching of the features may be matching features of the same estimated object in the preceding and following images (e.g., road markings, lane boundaries, or distant structures, etc.). The matching of the features may be performed, for example, using a local feature matching with transformers model by a transformer (e.g., using self-attention layers, cross-attention blocks, or feature-descriptor embeddings, etc.). The transformer may include, for example, self-attention between features in the same image and cross-attention between the same estimated features between the preceding and following images. The processor 118 may match features at a precise level, for example, at a sub-pixel level, based on a vector map output to the attentions (e.g., allowing fine-grained optical-flow estimation or micro-movement tracking, etc.).

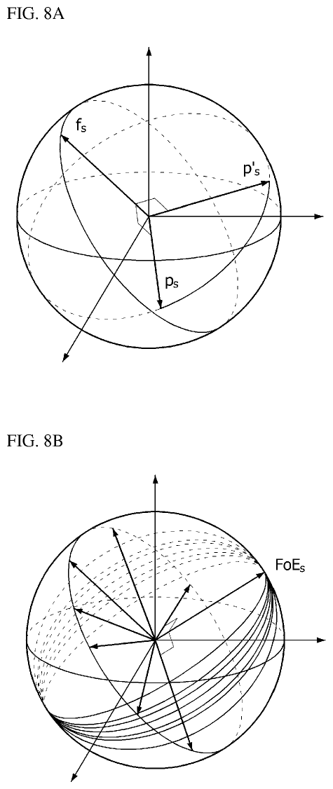

The processor 118 may generate the relative geometric relationship between the matched features. Specifically, homogeneous normalized image coordinates of the matched feature points may be represented by p′ and p as shown in FIG. 8A. FIGS. 8A and 8B are exemplary views showing identification of a focus of expansion (FoE). A relationship between two feature points may be represented by an essential matrix E as in the following Equation 1.

(p′)^{T}Ep=0 [Equation 1]

In Equation 1, E=[t]ₓR denotes an essential matrix, and [R^{T}|t] denotes a transformation matrix that may transform points between serial image frames (e.g., between t and t+1 frames during forward motion, etc.).

The processor 118 may estimate the essential matrix E using a method of robustly estimating a model when an outlier is included in the data, for example, random sample consensus (RANSAC) (e.g., removing mismatched feature pairs, transient obstacles, or reflection artifacts, etc.). Accordingly, the processor 118 may determine an inlier feature point and an outlier feature point. Since dynamic objects cause essential matrix errors, feature points of the dynamic objects may be removed as outliers (e.g., moving vehicles, pedestrians, or bicycles, etc.). In the estimated essential matrix E, rotation R and transformation t may be acquired through singular value decomposition. When the vehicle 100 performs the forward longitudinal movement, R denotes an essential matrix, and t=[0 01]^{T}. When it is determined that the rotation R is the essential matrix by the analysis of the essential matrix, the processor 118 may determine that the vehicle 100 performs the forward longitudinal movement.

Referring to operation S210 of FIG. 7, the processor 118 may identify an FoE in serial images in response to (or based on) the pure longitudinal movement and estimate a vanishing point in the image.

Specifically, the processor 118 may estimate the vanishing point by identifying the FoE based on an optical flow vector between spherical features formed by arranging matching features of serial images in a spherical coordinate system (e.g., mapping feature rays onto a unit sphere, etc.).

Describing the FoE in detail, the movement of the vehicle 100 may appear as the FoE in the image. Accordingly, during the pure longitudinal movement of the vehicle 100, the FoE may match an x_{w} axis of the world coordinate system shown in FIG. 6 (e.g., forward-driving direction, lane-center direction, or horizon-aligned direction, etc.).

To identify the position of the x_{w} axis of the world coordinate system shown in FIG. 6B in the camera coordinate system shown in FIG. 6A, the FoE may be estimated. The FoE is a convergence point of the optical flow vector in the image, but deriving the convergence point of a large number of vectors in the camera coordinate system may be a significant burden on a computational resource, for example, the processor 118. To this end, the processor 118 may use the spherical coordinate system to identify the convergence point of the vector (e.g., reducing vector-density complexity or avoiding planar singularities, etc.). As shown in FIG. 8A, the processor 118 may describe the matching feature points p and p′ as vectors pₛ and

$${p}_{s}^{′}$$

in the spherical coordinate system, and the optical flow vector f=p′−p may be formed as a circle in the spherical coordinate system. In the spherical coordinate system, circles are arranged on a plane, and the optical flow vector may be represented by a plane in the spherical coordinate system.

As may be seen in Equation 2, fₛ denotes a vector in the spherical coordinate system corresponding to the optical flow vector f in the image coordinate system. Since the FoE is the convergence point of the optical flow vector in the image, the vector of the FoE may represent a point where pₛ intersects

$${p}_{s}^{′}$$

as shown in FIG. 8B. As shown in FIG. 8B, the optical flow vector fₛ according to a plurality of matching feature points is present as a plurality of optical flow vectors on the same plane, and the plane in which the plurality of optical flow vectors are present may be formed as a circle. The normal vector with respect to the plane of the circle in which the plurality of optical flow vectors are present may be FoEₛ(e.g., representing the forward-motion direction or heading vector, etc.).

$${f}_{s} = {p}_{s} \times {p}_{s}^{′} \qquad [ Equation 2 ]$$

Since the optical flow vector fₛ and the vector FoEₛ of the FoE are orthogonal, a linear equation of a homogeneous system may be represented by Equation 3. The processor 118 may determine the vector of the FoE using Equation 3 and based on this, may estimate the vanishing point of the image (e.g., computing the dominant motion direction or estimating camera orientation drift, etc.).

fₛ·FoEₛ=0 [Equation 3]

Referring to operation S215 of FIG. 7, the processor 118 may generate pitch data and yaw data for each node based on the vanishing point.

Since the vector of the FoE, that is, the vector of the vanishing point, is the same as the x_{w} axis of the world coordinate system, the processor 118 may acquire the rotation vector r for each camera 102a using Equation 4.

r=FoEₛ=R_{y}(β)R_{z}(α)x_{w} [Equation 4]

In Equation 4, x_{w}=[1 0 0]^{T} denotes an unit vector, R_{z}(α) denotes a matrix representing rotation by an angle z_{w} about the z_{w} axis of the world coordinate system shown in FIG. 6B, and R_{y}(β) denotes a matrix representing rotation by an angle β about the y_{w} axis of the world coordinate system. The processor 118 may generate yaw data α and pitch data β for each camera 102a by Equation 4. The yaw data and pitch data generated by temporal calibration may be included in the node data of the nodes assigned for each camera 102a (e.g., capturing camera tilt, heading misalignment, or installation-angle deviations, etc.).

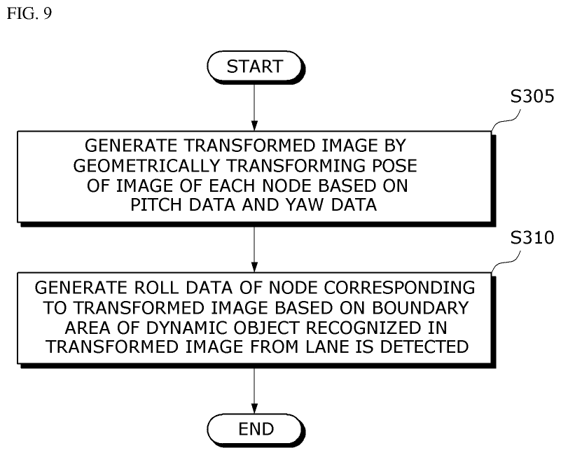

FIG. 9 is shows an example of a process of generating node data including roll data. A process of generating roll data in FIG. 9 may be spatial calibration. The spatial calibration may estimate a rotation angle, that is, roll data, by identifying an ego-lane space in which the vehicle 100 travels (e.g., detecting lane markings, lane-center regions, or adjacent-lane boundaries, etc.). When a dynamic object, for example, a preceding vehicle or a following vehicle, travels on the ego-lane, the spatial calibration may be performed. Since a boundary area (or an outline) of a vehicle recognized by object detection has a rectangular shape, the boundary area of the preceding or following vehicle may satisfy the Manhattan world assumption (e.g., vertical edges, horizontal edges, or axis-aligned edges, etc.).

Referring to operation S305 of FIG. 9, the processor 118 may generate a transformed image by geometrically transforming the pose of the image at each node based on the pitch data of each node and the yaw data of each node (e.g., compensating tilt, correcting drift, or normalizing viewpoint, etc.).

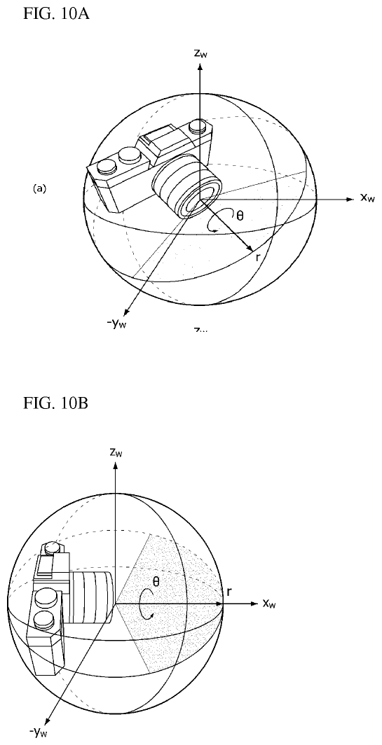

In relation to the geometric transformation of the image pose, the processor 118 may transform the image so that the rotation vector r and the unit vector x_{w} of the x_{w} axis of the world coordinate system are aligned, as shown in FIGS. 10A and 10B, to minimize a perspective error (e.g., vertical skew, horizon tilt, or lateral distortion, etc.).

The rotation vector r and the unit vector x_{w} may be aligned as follows.

$$r = {R}_{{x}_{w}}^{r} {x}_{w} \qquad [ Equation 5 ]$$

In Equation 5,

$${R}_{{x}_{w}}^{r} ∈ {ℝ}^{3 \times 3}$$

denotes a rotation matrix representing a geometric relationship between the unit vector x_{w} and the rotation vector r (e.g., mapping sensor orientation to world-frame alignment, etc.).

The processor 118 may use the rotation matrix

$${R}_{{x}_{w}}^{r}$$

to transform the image, and the rotation vector r and the unit vector x_{w} of the transformed image may be aligned. The processor 118 may generate a transformed image using Equation 6.

$${u}_{r} = {( {R}_{{x}_{w}}^{r} )}^{T} u \qquad [ Equation 6 ]$$

Here, u denotes homogeneous coordinates of the original image in the camera 102a corresponding to the node, and uᵣ denotes homogeneous coordinates of the transformed image transformed by the rotation matrix

$${R}_{{x}_{w}}^{r}$$

(e.g., resampling corrected pixels, warping camera rays, or applying rotational homographies, etc.).

Referring to operation S310 of FIG. 9, the processor 118 may generate roll data of a node corresponding to the transformed image based on the boundary area of the dynamic object recognized in the transformed image from which a lane is detected (e.g., bounding-box corners, contour edges, or detected vehicle outlines, etc.).

The processor 118 may use a learning-based object detection network to detect lanes and dynamic objects in the transformed image. The processor 118 may select a transformed image having an ego-lane among the transformed images for each node using the object detection network. The processor 118 may detect a dynamic object, for example, a preceding vehicle or a following vehicle, from the selected transformed image using the object detection network. The detected vehicle is identified by the boundary area, and the boundary area may be referred to as a bounding box or an outline (e.g., rectangular ROI, oriented-box contour, or pixel-level segmentation mask, etc.).

The processor 118 may derive a direction g_{θ} and size gₘ of a slope to identify components of the boundary area in the detected vehicle. The direction g_{θ} and size gₘ of the slope may be represented by complex numbers. The processor 118 may represent the components of the boundary area in a complex number coordinate system using the following Equation 7. The processor 118 may estimate a rotation angle θ corresponding to the roll data based on principal components of points represented in the complex number coordinate system (e.g., dominant-edge direction, major-axis orientation, or boundary-tilt angle, etc.).

$$\hat{w} = [ \begin{matrix}{\hat{w}}_{1} \\ \hat{{w}_{2}}\end{matrix} ] = {arg max}_{w} ( E ( {Z}^{2} ) ) \qquad [ Equation 7 ]$$

Here, regarding ŵ₁ and ŵ₂,

$$θ = {tan}^{- 1} ( \frac{{\hat{w}}_{2}}{{\hat{w}}_{1}} ) .$$

A node corresponding to a camera providing an image in which an ego-lane and a vehicle are detected may be referred to as a first node in the present disclosure. The first node may have first node data including pitch data, yaw data, and roll data generated by the temporal calibration of FIG. 7 and the spatial calibration of FIG. 9 (e.g., richer orientation cues, lane-aligned orientation, or vehicle-referenced roll angles, etc.). Anode corresponding to a camera related to an image in which no lane is detected may be referred to as a second node in the present disclosure. The second node may have second node data including pitch data and yaw data generated by the temporal calibration of FIG. 7 (e.g., front-side cameras, side-body cameras, or limited-visibility rear cameras, etc.).

For example, in the example of FIG. 3, the front wide-angle camera FT_CMR, the front fish-eye camera WD_FT_CMR, the rear wide-angle camera WD_RR_CMR, and the rear fish-eye camera RR_CMR capture an image of an ego-lane, and the cameras may be first nodes. The processor 118 may generate roll data of the first node based on the boundary area of the vehicle detected by the cameras. On the other hand, second nodes corresponding to cameras other than the above cameras cannot have roll data (e.g., side fisheye cameras or extreme-angle flank cameras, etc.).

The image may be transformed so that the rotation vectorr and the unit vector x_{w} are aligned, but a perspective error may be caused. In addition, in the case of the second node having no ego-lane within the field of view of the camera, the perspective error may increase or the detection of the preceding or following vehicle may fail (e.g., occlusions, low-texture scenes, or night-time conditions, etc.). To solve these problems, the spatiotemporal calibration to be described below may search for an image (or a frame) that minimizes the perspective error, generate pose graph data, and optimize the pose graph data (e.g., by loop-closure refinement, multi-frame smoothing, or temporal-spatial optimization, etc.).

Referring to operation S115 of FIG. 5, the processor 118 may generate edge data including the relative pose between the nodes.

The processor 118 may generate edge data based on the matching of images that are corrected so that the images of the nodes have the same perspective in three dimensions. The edge data may be generated as a relative pose of the second node with respect to the first node data of the first node. The relative pose may include relative pitch data, relative yaw data, and relative roll data (e.g., small-angle offsets, lateral shifts, or height-difference cues, etc.).

For example, since the nodes are generated by the temporal calibration and the spatial calibration, the processor 118 may generate edge data employed in the pose graph data for spatiotemporal calibration using an epipolar geometry that performs image matching to have the same perspective in three dimensions (e.g., enforcing epipolar constraints, matching rectified views, or aligning calibrated viewpoints, etc.).

Referring to operation S120 of FIG. 5, the processor 118 may generate spatiotemporal pose graph data that provides a loop set including at least one loop connecting the nodes to the edge in a time series based on the node data and the edge data.

The pose graph data may be generated to have a first node 502 having first node data, an edge 506 connected to the first node 502 and storing edge data, and a second node 504 connected to the edge 506 and having estimated node data. The estimated node data may be node data estimated in relation with the second node 504. The processor 118 may generate estimated node data of the second node 504 including estimated pitch data, estimated yaw data, and estimated roll data based on the first node data and the edge data (e.g., relative-orientation offsets, inter-camera angular differences, or small drift-correction rotations, etc.).

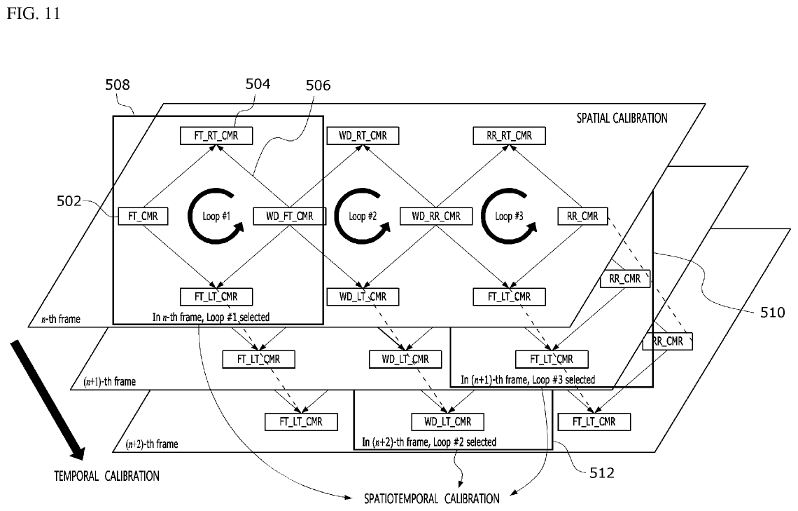

Describing an example with reference to FIG. 11, the processor 118 may estimate estimated node data of the second node 504 based on the first node data and the edge data of the first node 502. FIG. 11 is an exemplary view showing spatiotemporal pose graph data. In addition, the estimated node data of the second node 504 may be additionally generated based on first node data and edge data of a first node different from the first node 502 of FIG. 11 (e.g., a different wide-angle camera, a rear camera, or a side fish-eye camera, etc.). In FIG. 11, the second node may be a front right wide-angle camera FT_RT_CMR, a front left wide-angle camera FT_LT_CMR, a rear right wide-angle camera RR_RT_CMR, a rear left wide-angle camera RR_LT_CMR, a right fish-eye camera WD_RT_CMR, and a left fish-eye camera WD_LT_CMR. The estimated node data may be generated for each of the cameras listed above according to the above method. The second node 504 may receive roll data from the first node 502 through the estimated node data. Since the second node 504 receives different roll data from two first nodes connected by the edges 506, the estimated node data of the second node 504 may have an error (e.g., inconsistent roll angles, differing yaw offsets, or time-misaligned estimates, etc.).

FIG. 11 shows an example in which the spatiotemporal pose graph data has a plurality of loop sets (e.g., three loop sets) (e.g., frame-to-frame loop sets, time-indexed loop sets, or sequence-based loop sets, etc.). The acquisition time of the image, for example, the loop set for each image frame, may include at least one loop connecting the nodes by edges. As shown in FIG. 11, the spatiotemporal pose graph data may be generated so that the loop set for each image frame is provided in a time series (e.g., successive frames n, n+1, n+2, or staggered frames n, n+a, n+P, etc.).

Referring to operation S125 of FIG. 5, the processor 118 may select a loop error in a loop selected by a predetermined criterion for each loop set of the pose graph data and determine a node error based on the selected loop.

The loop selected by the predetermined criterion may be, for example, a loop having a minimum loop error in the loop set. The loop error may be set based on a difference of edge data of edges connected to at least one node in the loop (e.g., mismatched relative yaw, inconsistent pitch gain, or roll misalignment, etc.).

Regarding to the node error, the processor 118 may identify nodes that are common with other loop sets having different times from the selected loop in the loop set. The processor 118 may generate the node errors of the identified nodes based on the poses of the identified nodes, for example, the first node data, which are generated at different times (e.g., frame n vs. frame n+a comparisons, etc.).

Describing the loop error in detail, after three-dimensional pose graph data is generated, the processor 118 may check the loop error of each loop to select the root set, that is, the loop with the minimum loop error in the time-series loop (e.g., smallest rotational mismatch, smallest translation discrepancy, or smallest residual, etc.). Describing the example of FIG. 11, the second node 504 corresponding to the front right wide-angle camera FT_RT_CMR is connected to the first node 502 corresponding to the front wide-angle camera FT_CMR and the first node corresponding to the front fish-eye camera WD_FT_CMR. Such a connection relationship may be defined by Equations 8 and 9.

$${x}_{FT \_ RT \_ CMR}^{( 1 )} = {z}_{FT \_ CMR}^{FT \_ RT \_ CMR} {x}_{FT \_ CMR} \qquad [ Equation 8 ]$$

$${x}_{FT \_ RT \_ CMR}^{( 2 )} = {z}_{WD \_ FT \_ CMR}^{FT \_ RT \_ CMR} {x}_{WD \_ FT \_ CMR} \qquad [ Equation 9 ]$$

In Equations 8 and 9, x and z denote a node and an edge, respectively. From Equations 8 and 9, a difference between two nodes representing the loop error e_{FT_RT_CMR} may be defined by Equation 10.

$${e}_{FT \_ RT \_ CMR} = {( {x}_{FT \_ RT \_ CMR}^{( 1 )} )}^{- 1} {x}_{FT \_ RT \_ CMR}^{( 2 )} \qquad [ Equation 10 ]$$

Other loop errors e_{FT_LT_CMR}, e_{WD_RT_CMR}, e_{WD_LT_CMR}, e_{RR_RT_CMR}, and e_{RR_LT_CMR} shown in FIG. 11 may also be defined in the same manner as described above (e.g., by forward-backward comparisons, cross-camera relative pose checks, or pairwise calibration consistency, etc.). The processor 118 may select a loop of which loop error is close to an identity matrix (e.g., minimal deviation from expected calibration) as loops 508, 510, and 512 with the minimum loop error in the loop set.

Since the loops 508, 510, and 512 selected from each loop set are present at different times, the processor 118 may determine the node error according to the time difference. According to the example of FIG. 11, the processor 118 may set the node error e_{WD_FT_CMR} from the camera pose estimated at different times n and (n+α), that is, the first node data. The node error e_{WD_FT_CMR} may be defined as in Equation 11. In addition, the node error e_{WD_RR_CMR} may also be defined in the same manner as described above and may be represented by Equation 12.

$${e}_{WD \_ FT \_ CMR} = {( {x}_{WD \_ FT \_ CMR}^{( n )} )}^{- 1} {x}_{WD \_ FT \_ CMR}^{( n + α )} \qquad [ Equation 11 ]$$

$${e}_{WD \_ RR \_ CMR} = {( {x}_{WD \_ RR \_ CMR}^{( n + α )} )}^{- 1} {x}_{WD \_ RR \_ CMR}^{( n + β )} \qquad [ Equation 12 ]$$

Referring to operation S130 of FIG. 5, the processor 118 may generate optimal pose information for each node that minimizes the loop error and the node error of the identified node (e.g., performing joint optimization, applying nonlinear least squares, or updating pose parameters iteratively, etc.).

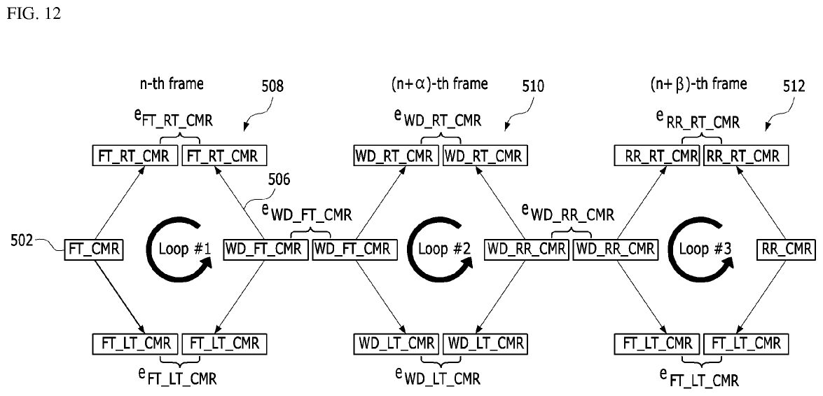

As shown in FIG. 12, the processor 118 may generate two-dimensional pose graph data including the loop error and the node error from the three-dimensional pose graph data of FIG. 11 (e.g., by projecting rotation components, simplifying graph edges, or reducing dimensionality, etc.). FIG. 12 is an exemplary view showing the generation of optimal pose information based on a loop error and a node error.

For example, the processor 118 may optimize all nodes by minimizing the loop errors selected in S120 and the node errors determined in S120 using Equation 13. FIG. 12 shows an example in which there are a total of eight loop errors and node errors, which are specifically e_{FT_RT_CMR}, e_{FT_LT_CMR}, e_{WD_FT_CMR}, e_{WD_RT_CMR}, e_{WD_LT_CMR}, e_{WD_RR_CMR}, e_{RR_RT_CMR}, and e_{RR_LT_CMR}. By optimization, the processor 118 may generate optimal pose information for each node that reduces (e.g., minimizes) loop errors and node errors (e.g., final calibrated camera orientations, refined extrinsic parameters, or stable multi-camera alignment, etc.).

$${\hat{x}}^{*} = arg {min}_{{x}^{*}} \sum {e}^{*} \qquad [ Equation 13 ]$$

An agrmin function is a function that returns node data (or nodes) having minimum loop errors and node errors, and x* denotes all nodes, \hat{x}* denotes an optimized node, and e* denotes all selected errors, that is, loop errors and node errors.

Referring back to operation S135 of FIG. 5, the processor 118 of the vehicle 100 may transform the image of the multi-camera 102a into a view at a predetermined perspective based on the optimal pose information and control the operation, for example, driving, of the vehicle 100 based on the view (e.g., BEV generation, obstacle avoidance, or lane-keeping, etc.).

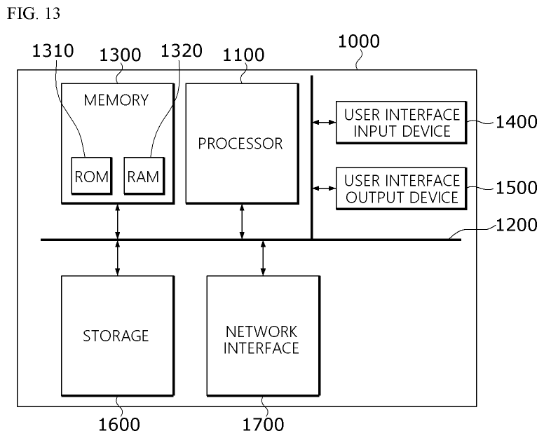

FIG. 13 shows an example computing system (e.g., a computing device of a vehicle or any other apparatus). One or more controllers, processors, etc. described herein, such as one or more components of the vehicle 100, one or more components of the server 200, one or more components of another vehicle 400, and any other components and devices disclosed herein, may be implemented by or in the computing system as shown in FIG. 13.

A computing system 1000 may include at least one processor 1100, memory 1300, a user interface input device 1400, a user interface output device 1500, a storage 1600, and a network interface 1700, which are connected with each other via a bus 1200. The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read-only memory (ROM) and a random-access memory (RAM).

Communication interface(s) (also referred to as communication device(s), communicator(s), communication module(s), communication unit(s), etc.), such as the network interface 1700, may allow software and/or data to be transferred between a device and one or more external devices, and/or between one or more components of a device. Communication interface(s) may include a receiver, a transmitter, a transceiver, a modem, a network interface and/or adapter (such as an Ethernet adapter), a radio transceiver, an antenna, a communication port, a Personal Computer Memory Card International Association (PCMCIA) slot and card, or the like. Software and data transferred via communication interface(s) may be in the form of signals, which may be electronic, electromagnetic, optical, infrared, or other signals capable of being received by communication interface(s). These signals may be provided to communication interface(s) via a communication path of a device, which may be implemented using, for example, wire or cable, fiber optics, a cellular link, a radio frequency (RF) link and/or other communications channels. Communication interface(s) may communicate using one or more communication protocols, such as Ethernet, Wi-Fi, near-field communication (NFC), Infrared Data Association (IrDA), Bluetooth, Bluetooth low energy (BLE), Zigbee, Long-Term Evolution (LTE), 5G New Radio (NR), vehicle-to-everything (V2X), a controller area network (CAN), or a local interconnect network (LIN), etc.

Accordingly, the operations of the method or algorithm described in connection with example embodiment(s) disclosed in the specification may be implemented with a hardware module, a software module, or a combination of the hardware module and the software module, which is executed by the processor 1100. The software module may reside on a storage medium (e.g., the memory 1300 and/or the storage 1600) such as RAM, a flash memory, ROM, an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

According to one example of the present disclosure, there is provided a method of calibrating a multi-camera, comprising: generating node data including a pose of a camera based on images of nodes assigned for each camera mounted on a vehicle; generating edge data including a relative pose between the nodes; generating spatiotemporal pose graph data having a loop set including at least one loop connecting the nodes with edges in a time series based on the node data and the edge data; generating optimal pose information for each node that minimizes a loop error in a loop selected by a predetermined criterion for each loop set of the pose graph data; and controlling the vehicle based on the optimal pose information. The loop error is set based on a difference of the edge data of the edges connected to the at least one node in the loop.

For examples, the generating of the node data may comprise: detecting presence of a behavior of the vehicle according to pure longitudinal movement based on serial images in a time series; identifying a focus of expansion (FoE) in the serial images to estimate a vanishing point in the images based on the forward longitudinal movement; and generating node data including pitch data and yaw data for each node based on the vanishing point.

For examples, the detecting of the presence of the behavior of the vehicle according to the pure longitudinal movement may comprise determining the pure longitudinal movement based on a relative geometric relationship between matching features in the serial images.

For examples, the identifying of the FoE to estimate of the vanishing point in the images may comprise identifying the FoE based on an optical flow vector between spherical features formed by arranging matching features of the serial images in a spherical coordinate system to estimate the vanishing point.

For examples, the generating of the node data may comprises: generating pitch data and yaw data for each node based on serial images in a time series; generating a transformed image by geometrically transforming a pose of the image at each node based on the pitch data and the yaw data; and generating roll data of the node corresponding to the transformed image based on a boundary area of a dynamic object recognized in the transformed image from which a lane is detected. The node data may be generated to have the pitch data, the yaw data, and the roll data.

For examples, the generating of the edge data may comprise generating the edge data based on matching of images corrected so that the images of the nodes have the same perspective in a three dimension.

For examples, the node data may comprise first node data of a first node and second node data of a second node. The first node data may comprise pitch data, yaw data, and roll data, and the second node data includes pitch data and yaw data. The generating of the edge data may comprise generating a relative pose of the second node with respect to the first node based on the first node data of the first node, wherein the relative pose includes relative pitch data, relative yaw data, and relative roll data.

For examples, the generating of the pose graph data may comprise: generating estimated node data of the second node including estimated pitch data, estimated yaw data, and estimated roll data based on the first node data and the edge data; and generating the pose graph data to include the first node having the first node data and the second node having the estimated node data.

For examples, the loop selected by the predetermined criterion may be a loop having a minimum loop error in the loop set.

For examples, the generating of the optimal pose information may comprise: selecting the loop based on the predetermined criterion for each loop set; identifying nodes that are common to other loop sets having different times from the loop for each loop; and generating optimal pose information for each node that minimizes the loop error and node errors of the identified nodes. The node error may be set based on poses of the identified nodes that are generated at different times.

According to another example of the present disclosure, there is provided a device for calibrating a multi-camera, comprising: a sensor unit having a plurality of cameras which detect images of a surrounding environment; a memory that stores at least one instruction; and at least one processor that executes the at least one instruction stored in the memory. The at least one processor is configured to: generate node data including a pose of the camera based on images of nodes assigned for each of the cameras; generate edge data including a relative pose between the nodes; generate spatiotemporal pose graph data having a loop set including at least one loop connecting the nodes with edges in a time series based on the node data and the edge data; generate optimal pose information for each node that minimizes a loop error in a loop selected by a predetermined criterion for each loop set of the pose graph data; and control the device based on the optimal pose information. The loop error is set based on a difference of the edge data of the edges connected to the at least one node in the loop.

According to the present disclosure, calibration of a multi-camera may be processed simultaneously without restrictions on mounting poses and fields of view of a plurality of cameras. In addition, by generating pose graph data by a loop including multi-camera-specific nodes, it is possible to flexibly perform calibration of the multi-camera even when the number of cameras increases or decreases.

According to the present disclosure, the method and device for calibrating a multi-camera may be provided to flexibly perform calibration of a multi-camera simultaneously without restrictions on mounting poses and fields of view of a plurality of cameras.

In addition, according to the present disclosure, by generating pose graph data by a loop including multi-camera-specific nodes, it is possible to flexibly perform calibration of a multi-camera even when the number of cameras increases or decreases.

Effects obtainable from the present disclosure are not limited to the above-described effects, and other effects that are not described will be able to be clearly understood by those skilled in the art to which the present disclosure pertains based on the following description.

While the exemplary methods of the present disclosure described above are represented as a series of operations for clarity of description, it is not intended to limit the order in which the steps are performed, and the steps may be performed simultaneously or in different order as necessary. To implement the method according to the present disclosure, the described steps may further include other steps, may include remaining steps except for some of the steps, or may include other additional steps except for some of the steps.

The various examples of the present disclosure are not a list of all possible combinations and are intended to describe representative examples of the present disclosure, and the matters described in the various examples may be applied independently or in combination of two or more.

In addition, various examples of the present disclosure may be implemented in hardware, firmware, software, or a combination thereof. In the case of implementing the present disclosure by hardware, the present disclosure may be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

The scope of the disclosure includes software or machine-executable commands (e.g., an operating system, an application, firmware, a program, etc.) for enabling operations according to the methods of various examples to be executed on an apparatus or a computer, a non-transitory computer-readable medium having such software or commands stored thereon and executable on the apparatus or the computer.

What is claimed is:

1. A method performed by an apparatus for a vehicle, the method comprising:
assigning, to each of a plurality of sensors of the vehicle, a respective node of a plurality of nodes;
generating, for each of the nodes and based on images obtained by a corresponding sensor of the plurality of sensors, node data, wherein the node data comprises sensor pose information of the corresponding sensor;
generating edge data indicating a relative pose between pairs of the nodes;
generating, based on the node data and the edge data, spatiotemporal pose data having at least one loop set, wherein each of the at least one loop set comprises at least one loop defined by node data and edge data associated with a different image acquisition time;
selecting, from the at least one loop set, a loop based on a predetermined criterion;
determining updated pose information for each of the nodes by reducing a loop error in the loop, wherein the loop error is defined based on differences in edge data for edges associated with at least one node of the loop;
outputting a signal indicating the updated pose information; and
controlling, based on the signal, an operation of the vehicle,

2. The method of claim 1, wherein the generating of the node data comprises:
detecting, based on the images obtained by the plurality of sensors, a forward longitudinal movement of the vehicle;
identifying, based on the forward longitudinal movement, a focus of expansion (FoE) in the images;
determining, based on the FoE, a vanishing point in the images; and
generating, based on the vanishing point, the node data for each of the nodes, wherein the node data comprises pitch data and yaw data for a corresponding node.

3. The method of claim 2, wherein the detecting of the forward longitudinal movement comprises determining the forward longitudinal movement based on changes in a relative geometric relationship between matching features across consecutive ones of the images.

4. The method of claim 2, wherein the identifying of the FoE comprises:
detecting matching features in consecutive ones of the images;
arranging the matching features in a spherical coordinate system;
determining optical flow vectors between the arranged matching features; and
identifying, based on the optical flow vectors, the FoE.

5. The method of claim 1, wherein the generating of the node data comprises:
generating, based on consecutive ones of the images, pitch data and yaw data for each of the nodes;
geometrically transforming the images based on the pitch data and the yaw data to generate a transformed image for each of the nodes;
detecting a boundary area in the transformed image;
determining a boundary area of a dynamic object;
detecting a lane from the transformed image; and
generating, based on the boundary area and the detected lane, roll data for each of the nodes, wherein the node data for each of the nodes comprises the pitch data, the yaw data, and the roll data.

6. The method of claim 1, wherein the generating of the edge data comprises generating the edge data based on matching between images that have been corrected so that the corrected images have a same perspective in a three dimension.

7. A vehicle comprising:
a plurality of sensors configured to obtain images associated with a surrounding environment of the vehicle; and
a processor circuit configured to cause the vehicle to:
assign, to each of the plurality of sensors, a respective node,
generate, for each of the nodes and based on images obtained by a corresponding sensor, node data comprising sensor pose information of the corresponding sensor,
generate edge data indicating a relative pose between pairs of the nodes,
generate, based on the node data and the edge data, at least one loop set, each loop set comprising at least one loop defined by node data and edge data associated with an image acquisition time,
select, from each of the loop sets, a loop having a minimum loop error among loops in the loop set, wherein the minimum loop error is defined based on differences in edge data for edges associated with at least one node of the loop,
update the sensor pose information for each of the nodes based on the selected loop,
generate, based on the images and the updated pose information, a unified view,
output a signal indicating the unified view, and
control, based on the signal, autonomous driving of the vehicle.

8. The vehicle of claim 7, wherein the processor circuit is configured to:
process variations in the images during a forward longitudinal movement of the vehicle to identify a focus of expansion (FoE) and a vanishing point, and
generate, based on the FoE and the vanishing point, pose information for the nodes.

9. The vehicle of claim 7, wherein the processor circuit is configured to:
generate, based on the images, pitch data, yaw data, and roll data for the nodes, and
generate edge data based on matching features in corrected images so that images for the nodes correspond to a same perspective in a three-dimensional space.

10. The vehicle of claim 7, wherein the processor circuit is configured to update pose information for the nodes based on loops of the at least one loop set that share common nodes.

11. An apparatus for a vehicle, the vehicle comprising:
a plurality of sensors configured to obtain images associated with a surrounding environment of the vehicle;
a processor; and
a memory storing at least one instruction that, when executed by the processor, is configured to cause the apparatus to:
assign, to each of the plurality of sensors, a respective node,
generate, for each node and based on images obtained by a corresponding sensor of the plurality of sensors, node data, wherein the node data comprises pose information of the corresponding sensor,
generate edge data indicating a relative pose between pairs of the nodes,
generate, based on the node data and the edge data, spatiotemporal pose graph data having at least one loop set, wherein each loop set comprises at least one loop defined by node data and edge data associated with a different image acquisition time,
select, from the at least one loop set, a loop based on a predetermined criterion,
determine updated pose information for each of the nodes by reducing a loop error in the loop, wherein the loop error is defined based on differences in edge data for edges associated with at least one node of the loop,
output a signal indicating the updated pose information, and
control, based on the signal, an operation of the vehicle.

12. The apparatus of claim 11, wherein the at least one instruction, when executed by the processor, is configured to cause the apparatus to:
detect, based on the images obtained by the plurality of sensors, a forward longitudinal movement of the vehicle,
identify, based on the forward longitudinal movement, a focus of expansion (FoE) in the images,
determine, based on the FoE, a vanishing point in the images, and
generate, based on the vanishing point, the node data for each of the nodes, wherein the node data comprises pitch data and yaw data for a corresponding node.

13. The apparatus of claim 12, wherein the at least one instruction, when executed by the processor, is configured to cause the apparatus to determine the forward longitudinal movement based on changes in a relative geometric relationship between matching features across consecutive ones of the images.

14. The apparatus of claim 12, wherein the at least one instruction, when executed by the processor, is configured to cause the apparatus to:
detect matching features in consecutive ones of the images,
arrange the matching features in a spherical coordinate system,
determine optical flow vectors between the arranged matching features,
identify, based on the optical flow vectors, the FoE, and
determine, based on the FoE, the vanishing point.

15. The apparatus of claim 11, wherein the at least one instruction, when executed by the processor, is configured to cause the apparatus to:
generate, based on consecutive ones of the images, pitch data and yaw data for each of the nodes,
geometrically transform the images based on the pitch data and the yaw data to generate a transformed image for each of the nodes,
detect a boundary area in the transformed image,
determine a boundary area of a dynamic object,
detect a lane from the transformed image, and
generate, based on the boundary area and the detected lane, roll data for each of the nodes, wherein the node data for each of the nodes comprises the pitch data, the yaw data, and the roll data.

16. The apparatus of claim 11, wherein the at least one instruction, when executed by the processor, is configured to cause the apparatus to generate the edge data based on matching between images that have been corrected so that the corrected images have a same perspective in a three dimension.

17. The apparatus of claim 11, wherein the node data for each of the nodes comprises pose information including pitch data, yaw data, and roll data,
wherein the nodes comprise at least a first node of the nodes and a second node of the nodes, and
wherein the at least one instruction, when executed by the processor, is configured to cause the apparatus to:
generate, based on first node data for the first node and second node data for the second node, a relative pose of the second node with respect to the first node, wherein the relative pose comprises relative pitch data, relative yaw data, and relative roll data.

18. The apparatus of claim 17, wherein the at least one instruction, when executed by the processor, is configured to cause the apparatus to:
generate, based on the first node data and the edge data, the second node data, wherein the second node data comprise estimated pitch data, estimated yaw data, and estimated roll data respectively corresponding to the relative pitch data, the relative yaw data, and the relative roll data, and
wherein the spatiotemporal pose data comprises the first node data and the second node data.

19. The apparatus of claim 11, wherein the predetermined criterion comprises selecting, from each of the at least one of loop set, a loop having a minimum loop error among loops in the at least one loop set.

20. The apparatus of claim 11, wherein the at least one instruction, when executed by the processor, is configured to cause the apparatus to:
identify, among the nodes, nodes that are common to loops of different ones of the at least one of loop set, each loop set corresponding to a different image acquisition time; and
determine updated pose information for the identified nodes by reducing node errors of the identified nodes, wherein the node errors are set based on differences in poses of the identified nodes associated with the different image acquisition time.
